(19) United States
(12) Patent Application Publication
(10) Pub. No.: US 2024/0060475 A1
(43) Pub. Date: Feb. 22, 2024

(54) Method for Assessing the Reliability of Data Relating to the Operation of a Wind Turbine

(71) Applicant: Scada International A/S, Silkeborg (DK)

(72) Inventor: Bo Lovmand, Hadsten (DK)

(21) Appl. No.: 18/211,839

(22) Filed: Jun. 20, 2023

Related U.S. Application Data
(63) Continuation of application No. 17/012,609, filed on Sep. 4, 2020, now abandoned.
Application No. 17/012,609 is a continuation of application No. PCT/DK19/50279, filed on Sep. 23, 2019.

(30) Foreign Application Priority Data
Sep. 25, 2018 (DK) PA 2018 00633

(51) Int. Cl. F03D 17/00

(52) U.S. Cl. CPC F03D 17/00; F05B 2260/80

(57) ABSTRACT

The invention relates to a method for assessing the reliability of data originating from monitoring a wind turbine during operation thereof; said method comprising the steps of: allowing an array of sensors to sense one or more specific parameter values of said wind turbine;
in respect of one or more sensors, transmitting said parameter value being sensed to a control system;
allowing said control system to register an alarm condition in case a sensed parameter value, or a combination of two or more sensed parameter values, represents a situation in which it is desired to shut down the wind turbine according to one or more predetermined criteria;
allowing said control system to provide an alarm value associated with said alarm condition; wherein said alarm value being selected from the group comprising: setting of said alarm and resetting of said alarm; wherein such alarm condition is associated with a specific alarm ID; wherein said method in respect of one or more alarm IDs furthermore comprising the steps of:
i) in respect of a specific time span, detecting one or more alarm values representing one or more settings and/or one or more resettings of said alarm having said alarm ID; and at the same time registering an associated time stamp relating to the point in time corresponding to the appearance of said one or more settings and/or one or more resettings of said alarm IDs;
ii) in respect of said time span, detecting information representing a power production value of said wind turbine as a function of time, said power production value being selected from the group comprising; information indicating that power is being produced by said wind turbine, and information indicating that no power is being produced by said wind turbine;
iii) in respect of said time span, or a portion thereof, correlating the information representing said power production value as a function of time on the one hand; with the time stamps of the one or more settings and/or resettings in respect of said alarm ID, on the other hand;
iv) determining whether or not a discrepancy exists between said information
   representing a power production value as a function of time on the one hand; and said time stamps detected in respect of said one or more settings and/or resettings in respect of said alarm ID, on the other hand;
v) in case a discrepancy is determined in step iv); annotating said specific alarm value in respect of said alarm ID as being unreliable in said time span or in said portion thereof.

### RELATED APPLICATIONS

This application is a continuation of U.S. application Ser. No. 17/012,609, filed Sep. 4, 2020, which is a continuation of International Application No. PCT/DK2019/050279, which designated the United States and was filed on Sep. 23, 2019, published in English, and which claims priority to Denmark Application No. 2018 00633, filed Sep. 25, 2018. The entire teachings of the above applications are incorporated herein by reference.

### FIELD OF THE INVENTION

The present invention relates in general to the field of wind turbines. More specifically the present invention relates in a first aspect to a method for assessing the reliability of data originating from monitoring a wind turbine during operation.

In a second aspect the present invention relates to a computer program product, which when loaded and/or operating on a computer, being configured for performing a method according to the first aspect of the present invention.

In a third aspect the present invention relates to a SCADA system (Supervisory Control And Data Acquisition System) comprising a computer program product as defined in respect of the second aspect of the present invention.

In a fourth aspect the present invention relates to the use of a correlation of information for assessing the reliability of data originating from monitoring said wind turbine during operation thereof.

In a fifth aspect the present invention relates to use of a correlation of information for correcting erroneous time stamps of alarm values.

In a sixth aspect the present invention relates to use of corrected data as obtained according to the method of the first aspect of the present invention for calculating the amount of time in respect of which the wind turbine, or selected parts, has been operating properly and/or improperly, regarding a specific type of condition triggering an alarm having a specific alarm ID.

### BACKGROUND OF THE INVENTION

Within the field of wind turbines and their operation it is customary that the manufacturers of the wind turbine or its parts are different from the company responsible for operating the wind turbine or wind farm.

In order to secure or guarantee the operator's viable economy in respect of operating a wind turbine or a wind farm it is customary that a contract exists between the manufacturer and the operator of the wind turbine or wind farm.

In such a contract it is stipulated which types of faults, errors and special conditions leading to missing or reduced power production is the responsibility of the manufacturer and which types of faults, errors and special conditions leading to missing or reduced power production are the responsibility of the operator.

Typically, such a contract will also contain a detailed calculation schedule dividing the value represented by the power produced by a wind turbine between the manufacturer and the operator according to a predetermined schedule of allocations. Thus the manufacturer will have an incentive to continuously improve the quality of the components making up the wind turbine in order to reduce the downtime of the wind turbine. This will eventually secure an optimum energy production.

However, even in a situation in which no such contract exists or in a situation in which the term of such a contract has expired, it is of high interest for the operator of the wind turbine to continuously gain information relating to the operational state of the wind turbine, including information relating to the duration of and in which specific periods of time the wind turbine has been operating properly or improperly.

A wind turbine is operated by the use of a control system which monitors a vast number of parameters associated with the operation of the wind turbine.

The monitoring of the parameters is performed by using a number of sensors arranged in and on the wind turbine. Each sensor is responsible for sensing a specific parameter or group of parameters.

The control system is configured to use the parameters sensed by the sensors as inputs in the calculation of a feedback procedure. In this way a wind turbine can be operated automatically according to a predetermined algorithm using monitored parameters, sensed by sensors, to create a feedback response which in turn is used for controlling the wind turbine.

In addition to using the parameters sensed by the sensors as inputs in the calculation of a feedback procedure for controlling the wind turbine, the control system is also configured, from the sensed parameters, to determine whether a critical event has happened.

A critical event will make the control system instruct the wind turbine to shut down, i.e. to bring the wind turbine into a state in which the rotor stops rotating so that no power is being produced.

Many different parameter values sensed by the sensors, or combination of parameter values, may lead to a situation in which the control system has been predetermined to identify a critical event and subsequently shut down the wind turbine. Each such critical event situation is associated with an associated alarm ID, identifying which type of critical event is the cause for shutting down the wind turbine.

Typically, a control system of a wind turbine is coupled to a monitoring system which receives and stores on a data storage, data relating to the operation of the wind turbine. The operational data may specifically comprise information relating to the setting and resetting of various alarms being sent to the control system and also the time stamps indicating the point in time of such settings and resettings of alarms.

Accordingly, the operational data may represent valuable information in the process of determining the amount of time in which the wind turbine, or specific parts thereof, have been operating properly or improperly.

As already indicated, such information is used when dividing the value represented by the power produced by a wind turbine between the operator and the manufacturer(s) of the wind turbine or its parts; or simply is used for gaining detailed insight into the operational state of the wind turbine.

It may happen that the data received by the monitoring system from the control system and relating to the setting and resetting of various alarms and their associated time stamps, indicating the point in time of such settings and resettings of alarms, are not being properly transmitted from the control system of the wind turbine to the monitoring system.

If this happens, the data registered by the monitoring system does not represent an accurate picture of the operational state of the wind turbine.

An incorrect picture of an operational state of a wind turbine will lead to an allocation of the value represented by the power produced by a wind turbine between the manufacturer and the operator in a way which deviates from the true situation and thereby the actual allocation of value being calculated does not comply with the original intention as stipulated by the contract between the operator and the manufacturer of the wind turbine.

Accordingly, a need persists to secure a more accurate monitoring and storing of data relating to the timewise operational state and alarm situation of a wind turbine or a wind farm.

The present invention in its various aspects seeks to meet this need.

Accordingly, it is an objective of the present invention to provide methods, uses and devices which solves the problems relating to monitoring and logging data associated with the timewise operational state and alarm situation of a wind turbine.

### BRIEF DESCRIPTION OF THE INVENTION

These objectives are fulfilled according to the first, the second, the third, the fourth, the fifth and the sixth aspects of the present invention.

Accordingly, the first aspect of the present invention relates to a method for assessing the reliability of data originating from monitoring a wind turbine during operation; the method comprising the steps of:
allowing an array of sensors to sense one or more specific parameter values of the wind turbine;
in respect of one or more sensors, transmitting said parameter value being sensed to a control system;
allowing the control system to register an alarm condition in case a sensed parameter value, or a combination of two or more sensed parameter values, represents a situation in which it is desired to shut down the wind turbine according to one or more predetermined criteria;
allowing the control system to provide an alarm value; wherein the alarm value is selected from the group comprising: setting of the alarm and resetting of the alarm; wherein the alarm condition is associated with a specific alarm ID;
wherein the method in respect of one or more alarm IDs further comprises the steps of:
   i) in respect of a specific time span, detecting one or more alarm values representing one or more settings and/or one or more resettings of the having said alarm ID; and at the same time registering an associated time stamp relating to the point in time corresponding to the appearance of the one or more settings and/or one or more resettings of the alarm IDs;
   ii) in respect of the time span, detecting information representing a power production value of the wind turbine as a function of time, the power production value being selected from the group comprising; information indicating that power is being produced by the wind turbine, and information indicating that no power is being produced by the wind turbine;
   iii) in respect of said time span, or a portion thereof, correlating the information
   representing the power production value as a function of time; with the time stamps of the one or more settings and/or resettings in respect of the alarm ID;
   iv) determining whether or not a discrepancy exists between the information
   representing a power production value as a function of time; and said time stamps detected in respect of the one or more settings and/or resettings in respect of the alarm ID;
   v) in case a discrepancy is determined in step iv); annotating the specific alarm value in respect of the alarm ID as being unreliable in the time span or in a portion thereof.

In a second aspect the present invention relates to a computer program product, which when loaded and/or operating on a computer, is configured to perform a method according to the first aspect of the present invention.

In a third aspect the present invention relates to a SCADA system (Supervisory Control And Data Acquisition System) comprising a computer program product as defined in respect of the second aspect of the present invention.

In a fourth aspect the present invention relates to the use of a correlation between information representing a power production value as a function of time of a wind turbine; and the time stamps of one or more settings and/or one or more resettings in respect of an alarm ID being detected in the operation of said wind turbine, for assessing the reliability of data originating from monitoring said wind turbine during operation thereof.

In a fifth aspect the present invention relates to the use of a correlation between information representing a power production value as a function of time of a wind turbine; and the time stamps of one or more settings and/or one or more resettings in respect of an alarm ID being detected in the operation of the wind turbine, for correcting erroneous time stamps of alarm values.

In a sixth aspect the present invention relates to use of corrected data as obtained according to the method of the first aspect of the present invention for calculating the amount of time in respect of which the wind turbine, or its parts, has been operating properly and/or improperly, regarding a specific type of condition triggering an alarm having a specific alarm ID.

The present invention in its various aspects provides for assessing the reliability of operational data being supplied from a control system of a wind turbine to a corresponding monitoring system. In special embodiments the present invention furthermore provides for correcting such unreliable data being supplied from a control system of a wind turbine to a corresponding monitoring system.

Thereby the operational quality of the wind turbine can be assessed subsequent to the operation of the wind turbine.

### BRIEF DESCRIPTION OF THE FIGURES

FIG. 1 schematically illustrates some of the components of a wind turbine employed in the present invention.

FIG. 2A and FIG. 2B illustrate one example of the correlation of various information in the method according to the method of first aspect of the present invention.

FIG. 3A and FIG. 3B illustrate another example of the correlation of various information in the method according to the method of first aspect of the present invention.

### DETAILED DESCRIPTION OF THE INVENTION

The First Aspect of the Present Invention

The first aspect of the present invention relates to a method for assessing the reliability of data originating from monitoring a wind turbine during operation; the method comprising the steps of:
allowing an array of sensors to sense one or more specific parameter values of the wind turbine;
in respect of one or more sensors, transmitting the parameter value being sensed to a control system;
allowing the control system to register an alarm condition in case a sensed parameter value, or a combination of two or more sensed parameter values, represents a situation in which it is desired to shut down the wind turbine according to one or more predetermined criteria;
allowing the control system to provide an alarm value in case an alarm condition is registered;
wherein the alarm value is selected from the group comprising: setting of the alarm and resetting of the alarm; wherein the alarm condition is associated with a specific alarm ID;
wherein the method in respect of one or more alarm IDs further comprises the steps of:
   i) in respect of a specific time span, detecting one or more alarm values representing one or more settings and/or one or more resettings of the type of alarm; and at the same time registering an associated time stamp relating to the point in time corresponding to the appearance of the one or more settings and/or one or more resettings of the alarm IDs;
   ii) in respect of the time span, detecting information representing a power production value of said wind turbine as a function of time, the power production value being selected from the group comprising; information indicating that power is being produced by the wind turbine, and information indicating that no power is being produced by the wind turbine;
   iii) in respect of the time span, or a portion thereof, correlating the information
   representing said power production value as a function of time on the one hand; with the time stamps of the one or more settings and/or resettings in respect of said alarm ID, on the other hand;
   iv) determining whether or not a discrepancy exists between said information
   representing a power production value as a function of time; and the time stamps detected in respect of the one or more settings and/or resettings in respect of the alarm ID;
   v) in case a discrepancy is determined in step iv); annotating the specific alarm
   value in respect of the alarm ID as being unreliable in the time span or in the portion thereof.

Accordingly, the present invention in a first aspect provides for utilizing available information for assessing the reliability of the data received by a monitoring system from the control system of the wind turbine in relation to the timewise operational state and alarm situation of the wind turbine during operation thereof.

In the following description and in the appended claims the following definitions may be adhered to:
Alarm value: An alarm value is a value being provided by the control system of the wind turbine. An alarm value can have one of two values; “set” or “reset”. A “set” value indicates that a critical event has been detected, which results in the wind turbine being shut down by the control system. A “reset” value indicates a situation in which the critical value, setting the alarm in the first place, is no longer present.
Time stamp: A time stamp in respect of the setting or resetting of an alarm shall be construed to mean the point in time at which the alarm is being set or reset.
Discrepancy: A discrepancy shall be construed to mean that an inconsistency exists between information indicating that within a given period of time, power is being produced by the wind turbine; and information indicating that an alarm is set in that same period of time.

In the description and in the appended claims the definition of the invention of the first aspect includes the term “allowing” followed by an action which is allowed to be performed. In this respect it should be noted that the action following the term “allowing” is not to be construed as an optional feature which may or may not be included. Rather, the term “allowing” as used in the definitions of the present invention should be construed in such a way that, in the invention, the action following the term “allowing” indeed is carried out (taking into account any stated or implied conditional prerequisite).

In one embodiment of the method according to the first aspect of the present invention the system is connected to a monitoring system, wherein the monitoring system is configured, in respect of one or more alarm IDs, for receiving and storing data relating to the alarm values and associated time stamps, as detected in step i) and data relating to the information representing a power production value as a function of time, as detected in step ii). Hereby a record of monitored data can be kept which allows subsequent, i.e. non-real time assessment of the reliability of the data being monitored.

In one embodiment of the method according to the first aspect of the present invention step iii), iv) and v), and optionally also step i) and ii) are being performed by the monitoring system.

In one embodiment of the method according to the first aspect of the present invention the number of sensors in the array of sensors and/or the number of alarm IDs of the wind turbine independently is selected from the ranges of 5-2000 or more, such as 10-1000, for example, 25-900, such as 50-800, for example 100-800, e.g. 200-700, such as 300-600 or 400-500.

Such numbers of sensors are common in modern wind turbines.

In one embodiment of the method according to the first aspect of the present invention the one or more sensors relate to sensors for sensing:
mechanical parameters such as undesirably low level of gear oil, undesirably high bearing temperature, stuck pitch actuator, undesirably high yaw misalignment; and/or
grid parameters such as undesirably low grid frequency, undesirably high grid voltage, phase asymmetry; and/or
environmental parameters, such as undesirably high wind speed, undesirably low ambient temperature, undesirably low wind speed; and/or
external command parameters, such as remote stop instructions; and/or
normal operation parameters such as untwisting cables, performance of self-test, state of heating component;
a presence of condensate in the electrical system, such as in the converter.

These types of problems typically could trigger one or more alarm IDs.

In one embodiment of the method according to the first aspect of the present invention the representation of the power production as a function of time, which is being detected in step ii) relates to one of the following: power produced, such as average power produced in a time segment of a predetermined duration; torque exhibited by the rotor axle of the wind turbine, such as average torque exhibited by the rotor axle of the wind turbine in a time segment of a predetermined duration; angular velocity measured in respect of the rotor axle of the wind turbine, such as average angular velocity measured in respect of rotor axle of the wind turbine in a time segment of a predetermined duration; current induced in the generator of the wind turbine, such as average current induced in the generator of the wind turbine in a time segment of a predetermined duration; voltage induced in the generator of the wind turbine, such as average voltage induced in the generator of the wind turbine in a time segment of a predetermined duration; general information that the operational state of the wind turbine is being OK or not OK.

These types of representations of the power production as a function of time are suitable for being employed in the method according to the first aspect of the present invention.

In one embodiment of the method according to the first aspect of the present invention the time span is having a duration of 1-600 min, such as 2-550 min, for example 3-500 min, such as 4-450 min, such as 5-400 min, e.g. 6-350 min, such as 7-300 min, for example 8-250 min, e.g. 9-200 min, such as 10-150 min, for example 15-120 min, such as 30-90 min or 45-60 min.

These durations of time spans are suitable for being employed in the method according to the first aspect of the present invention.

In one embodiment of the method according to the first aspect of the present invention the discrepancy as determined in step iv) is caused by lack of detection of a resetting of the alarm ID, or is caused by lack of detection of a setting of the alarm ID.

These two causes are causes which can be detected according to the method according to the first aspect of the present invention.

In one embodiment of the method according to the first aspect of the present invention the method further comprises the following step:
vi) in case no discrepancy is determined in step iv); annotating the specific alarm value of the alarm ID as being reliable in said time span or in the portion thereof.

Hereby, the method can be used to acknowledge reliability of data transmitted from the control system to the monitoring system.

In one embodiment of the method according to the first aspect of the present invention the method is being performed automatically.

In one embodiment of the method according to the first aspect of the present invention the method is being performed continuously or regularly in respect of successive time spans.

These two embodiments in a conveniently way ensures continuous assessment of the reliability of the data in question.

In one embodiment of the method according to the first aspect of the present invention the method further comprises correcting an alarm value, which in step v) has been annotated as being unreliable.

Whereas the method of the first aspect of the present invention, as described in the above embodiments, merely related to assessment of the reliability of data, this latter embodiment furthermore enables correction of data which has been found to be unreliable.

In one embodiment of the method according to the first aspect of the present invention the discrepancy as determined in step iv) is caused by lack of detection of a resetting of the alarm ID; wherein said correction of the alarm value comprises the following steps:
a) from the detection of the information representing a power production value as detected in step ii), determine the first point in time, subsequent to the time stamp representing the setting of the alarm ID, at which the power production value shifts from indicating that no power is being produced to indicating that power is being produced;
b) define as the corrected reset time of the alarm ID, a moment in time following the first point in time, as determined in step a).

Thus data relating to missing the resetting of an alarm can be corrected.

In one embodiment of the method according to the first aspect of the present invention the information representing a power production value is being provided as averaged values being averaged over a segment of time; and wherein step b) comprises:
define as the corrected reset time of the alarm ID, a moment in time falling in a time range having a starting point and an end point;
wherein the starting point of the time range being the first time, at which the power production value shifts from indicating that no power is being produced to indicating that power is being produced, as determined in step a); and
wherein the end point of the time range being a point in time falling subsequent to said starting point by a duration corresponding to duration of the time segment.

This embodiment sets out a simple way to correct data relating to the missing of the resetting of an alarm.

In one embodiment of the method according to the first aspect of the present invention the discrepancy as determined in step iv) is caused by lack of detection of a setting of the alarm ID; wherein the correction of the alarm value comprises the following steps:
a) from the detection of the information representing a power production value as detected in step ii), determine the first point in time, preceding the time stamp representing the resetting of the alarm ID, at which the power production value shifts from indicating that power is being produced to indicating that no power is being produced;
b) define as a corrected set time of the alarm ID, a moment in time preceding the first point in time, as determined in step a).

Thus data relating to missing the setting of an alarm can be corrected.

In one embodiment of the method according to the first aspect of the present invention the information representing a power production value is being provided as averaged values being averaged over a segment of time; wherein step b) comprises:
define as a corrected set time of the alarm ID, a moment in time falling in a time range having a starting point and an end point;
wherein the end point of the time range being the first point in time, at which the power production value shifts from indicating that power is being produced to indicating that no power is being produced, as determined in step a);
wherein the starting point of said time range being a point in time falling prior to the end point by a duration corresponding to the duration of the time segment.

This embodiment sets out a simple way to correct data relating to the missing of the setting of an alarm.

In one embodiment of the method according to the first aspect of the present invention the time segment is having a duration of 0.1 s-600 min, such as 0.5 s-550 min., e.g. 1 s-500 min., such as 5 s-450 min., e.g. 10 s-400 min., such as 15 s-350 min., such as 30 s-300 min., for example 45 s-250 min., e.g. 1 min-200 min, such as 5 min.-150 min., for example 10 min.-100 min., such as 15 min.-45 min.

These durations of time segments are suitable for being employed in the method according to the first aspect of the present invention.

In one embodiment of the method according to the first aspect of the present invention the method involves keeping a data log, logging a data set relating to one or more of the following entries: alarm values being detected, including the corresponding time stamp; information identifying the alarm ID in respect of which alarm values are being detected; the time span in respect of which a specific alarm value is being annotated as being unreliable, any corrected alarm values as determined by said method, and optionally also the corresponding corrected time stamps relating to settings and/or resettings of an alarm ID.

Keeping a data log ensures the ability to inspect data which has been logged at a point in time subsequent to the time of logging.

In one embodiment of the method according to the first aspect of the present invention and in respect of one or more of the alarm IDs, a first original data log is being kept which logs and stores original data being supplied from the control system; and wherein a Corrected Data Log CDL is being kept, which logs and stores corrected data which represents original data that has been corrected by the method according to any of the preceding claims.

Thus the original data is easily distinguishable from the corrected data.

In one embodiment of this embodiment of the first aspect of the present invention the original data and the corrected data is independently selected from the group comprising: alarm ID, original time stamps relating to setting times and/or resetting times of a specific alarm ID, corrected time stamps relating to setting times and/or resetting times of a specific alarm ID; information relating to the power production value as a function of time.

These data are relevant in the assessment of the time spans in respect of which the wind turbine is operating properly or not properly.

In one embodiment of this embodiment of the first aspect of the present invention the power production value of the wind turbine as a function of time, as determined in step ii) further and/or alternatively comprises: information indicating that power potentially could be produced by the wind turbine in its current state, and information indicating that no power potentially could be produced by the said wind turbine in its current state.

This embodiment ensures that in a case where the wind turbine is capable of producing power or not capable of producing power, but currently does not do so, e.g. because the wind is too weak, information could be provided by the control system that the wind turbine either is capable of producing power or not capable of producing power, as the case may be. Hereby it is ensured that the correlation performed in step iii) makes sense even though the wind turbine currently does not produce any power.

The Second Aspect of the Present Invention

The second aspect of the present invention relates to a computer program product, which when loaded and/or operating on a computer, is configured for performing a method according to the first aspect of the present invention.

The Third Aspect of the Present Invention

The third aspect of the present invention relates to a SCADA system (Supervisory Control And Data Acquisition System) comprising a computer program product as defined in respect of the second aspect.

The Fourth Aspect of the Present Invention

The fourth aspect of the present invention relates to a use of a correlation between information representing a power production value as a function of time of a wind turbine; and the time stamps of one or more settings and/or one or more resettings in respect of an alarm ID being detected in the operation of the wind turbine, for assessing the reliability of data originating from monitoring the wind turbine during operation.

The Fifth Aspect of the Present Invention

The fifth aspect of the present invention relates to a use of a correlation between information representing a power production value as a function of time of a wind turbine; and the time stamps of one or more settings and/or one or more resettings in respect of an alarm ID being detected in the operation of the wind turbine, on the other hand, for correcting erroneous time stamps of alarm values.

The Sixth Aspect of the Present Invention

The sixth aspect of the present invention relates to a use of corrected data as obtained according to the method of the first aspect of the present invention for calculating the amount of time in respect of which the wind turbine, or its parts, has been operating properly and/or improperly, regarding a specific type of condition triggering an alarm having a specific alarm ID.

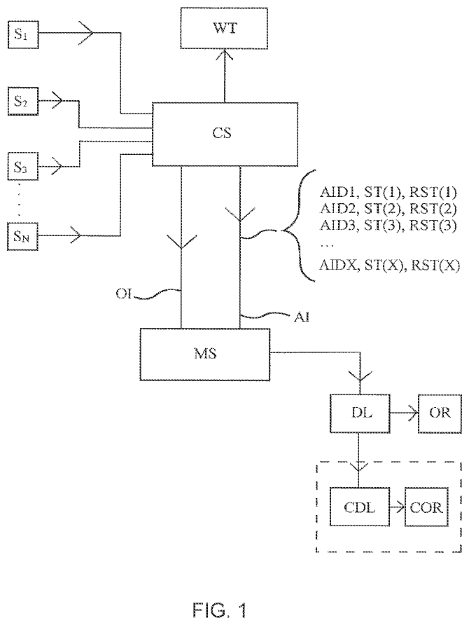

Referring to the figures in order to better illustrate the present invention, FIG. 1 is a schematic diagram which in a very simplified manner illustrates the operation of a wind turbine.

FIG. 1 shows the wind turbine WT which is being controlled by a control system CS according to a predetermined control algorithm. A number of sensors S₁, S₂, S₃ . . . S_{N} sense various parameter values during the operation of the wind turbine. These parameter values are being transmitted to the control system CS.

Accordingly, the parameter values being transmitted to the control system is used as input in the algorithm determining a proper feedback reaction in respect of operating the wind turbine. Various operation information OI is being sent to a monitoring system MS during operation of the wind turbine.

In addition to merely receiving parameter values from the sensors S₁, S₂, S₃ . . . S_{N} and providing feedback in the operation of the wind turbine, the control system CS is also configured, from the parameter values received from the sensors S₁, S₂, S₃ . . . S_{N}, to determine whether or not a critical event has been encountered which could jeopardize the short term and/or long term integrity of the wind turbine or its components. The determination of whether a critical event has occurred is being provided according to a predetermined algorithm.

In case the control system detects that a critical event is present, the control system instructs the wind turbine WT to shut down.

Various values of the parameters transmitted from the sensors S₁, S₂, S₃ . . . S_{N}, or combination of such values may represent a critical event which result in the wind turbine being shut down. A critical event triggers the provision of an alarm value with an associated alarm ID, where the alarm ID identifies which reason is responsible for the setting of an alarm. The alarm value in respect of a given alarm ID X may be either setting of alarm ID X or resetting of alarm ID X.

Besides providing the monitoring system MS with operational information OI, alarm information AI is also provided to the monitoring system MS. Such alarm information may in respect of a given alarm ID X relate to the identity of alarm ID X in question, i.e. A ID X, and the time stamp associated with the setting time of alarm ID X, i.e. ST(X), and the time stamp associated with the resetting time of alarm ID X, i.e. RST(X).

The operational information OI and the alarm information AI received by the monitoring system MS may be logged in a data log DL. From the data log DL may be retrieved an operational report OR, setting out details relating to the operation of the wind turbine, especially the duration of time periods at which the wind turbine WT or specific components thereof are operating properly or not properly.

The operational report OR is used in the calculation of the sharing of the value represented by the power produced by the wind turbine between the operator of the wind turbine and the manufacturer of the wind turbine, or its parts.

In a situation in which the monitoring system MS does not receive correct information relating to a critical event from the control system CS, the data log DL, from which the operational report OR is retrieved, will not reflect the true operational conditions of the wind turbine WT.

Thus, the calculation of the value represented by the power produced by the wind turbine, and its allocation between the operator of the wind turbine and the manufacturer of the wind turbine, or its parts will not be performed in accordance with the original intentions agreed upon.

Typical reasons that the monitoring system MS does not receive correct information from the control system CS may relate to missing information relating to settings and resettings of a specific alarm ID representing a critical event being detected by the control system CS. The present invention seeks to solve the problems of the above working mode of the wind turbine WT.

This solution is brought about in that unreliable information received by the monitoring system MS from the control system CS and represented in the operational report is identified and corrected. Thereby a corrected operational report COR may be obtained as indicated in FIG. 1 by the dashed rectangle.

It should be noted that the sensors S₁, S₂, S₃ . . . S_{N} in FIG. 1 are shown separate from the wind turbine WT. This is only for the sake of simplicity. In a real life situation many of the sensors S₁, S₂, S₃ . . . S_{N} will be located in or on the wind turbine WT itself.

### Example 1

This example illustrates one embodiment of the present invention, where a wind turbine is monitored during its operation and where data origination from such monitoring of the wind turbine is found unreliable and subsequently corrected.

The wind turbine in this example comprises an array of sensors arranged at various parts and components of the wind turbine and each of these sensors are configured to provide to a control system, parameter data relating to the parameter sensed by the individual sensor. The wind turbine is in turn configured to register that a critical event is present in case a sensed parameter value, or a combination of two or more sensed parameter values, represents a situation in which it is desired to shut down the wind turbine. Accordingly, a critical event will always make the control system shut down the wind turbine.

When and when not to shut down the wind turbine is embedded in the control system according to one or more predetermined criteria.

The reason for desiring to shut down the wind turbine is that the critical event being sensed, either in the short term or in the long term represents an unhealthy condition for the wind turbine or the integrity thereof, or even worse, that the critical event may pose hazards to personnel in the vicinity of the wind turbine.

When an operational condition is being encountered which corresponds to a critical event which is being registered by that control system, and also when such a critical condition ceases to be present, the control system provides an alarm value. The alarm value being selected from the group comprising: setting of the alarm and resetting of the alarm.

Besides comprising a control system for controlling the wind turbine, the wind turbine is also coupled to a monitoring system which is configured for logging and storing various data. In this simplified example the data which is being logged and stored by the monitoring system is the alarm value of a specific alarm (i.e. setting of a specific alarm ID and resetting of a specific alarm type ID and the associated time stamps associated with the setting and the resetting of that alarm ID).

Furthermore, the monitoring system also logs and stores information representing a power production value of said wind turbine as a function of time; that is information indicating whether power is being produced by said wind turbine, or whether no power is being produced by said wind turbine.

As we will see below, correlating time stamps of the setting and resetting of an alarm ID with information relating to a power production value allows for assessing the reliability of the time stamps of such settings and resettings of an alarm ID, and in case such time stamps are being annotated as unreliable, furthermore provides for correcting such time stamps.

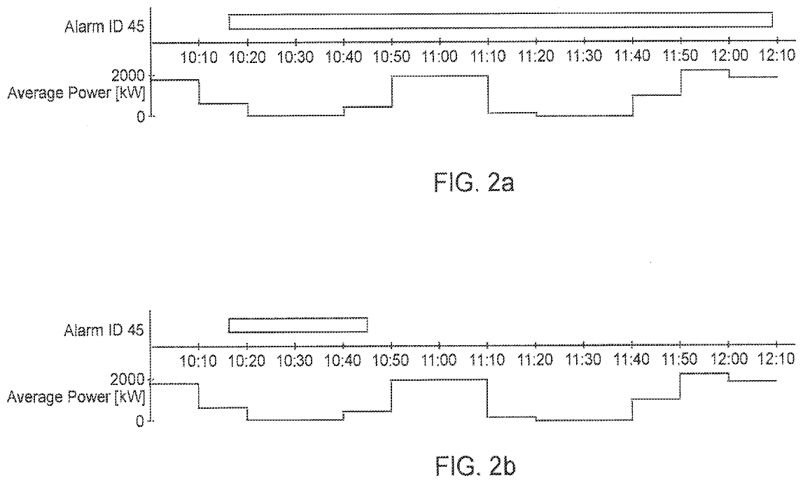

The invention is further illustrated with reference to FIGS. 2a and 2b.

FIG. 2a is a graphical illustration representing data which have been logged and stored by a monitoring system. The data received by the monitoring system is received from the control system controlling the wind turbine.

FIG. 2a illustrates that a wind turbine has been monitored during a time span ranging from approximately 10:00 to approximately 12:10.

Alarm values have been monitored and it appears that at approximately 10:17 the setting of Alarm ID 45 is detected. The setting of Alarm ID 45 lasts until approximately 12:09. This setting of the Alarm ID 45 is represented by the solid bar in FIG. 2a.

The monitoring system of this example also logs and stores information representing a power production value as a function of time which indicates whether or not power is being produced. In the present example the information representing a power production value is in the form of an average power production, averaged over successive segments of time, each of a duration of 10 min. The information representing a power production value is seen as the lower curve in FIG. 2a.

It is seen that at approximately 10:20 to 10:40 the average power production is zero, correctly corresponding to the registration of the Alarm ID 45 at approximately 10:17, the event of which will cause the control system of the wind turbine to shut down the wind turbine. However, it is also seen from the average power curve in FIG. 2a that between 10:40 and 10:50 the wind turbine starts producing power again. This resuming of power production is inconsistent with the Alarm ID 45 having a set-value in the time period between 10:40 and all the way through approximately 12:09.

Therefore, as the wind turbine between 10:40 and 10:50 has resumed producing power, it can be concluded that the Alarm ID 45 cannot have a set-value (because every set-value registered originates from a critical event which will cause the control system of the wind turbine to shut down).

Accordingly, from the data corresponding to FIG. 2a it can be deduced that the value of the Alarm ID 45 cannot be correct in the full time range of approximately 10:17 through 12:09. Hence, according to the method of the of the present invention the value of the Alarm ID 45 is annotated as unreliable.

It can be further deduced from FIG. 2a that as power production is being resumed at a point in time between 10:40 and 10:50, a reset value in respect of the Alarm ID 45 has not been received in this time period from 10:40 to 10:50.

Accordingly, in the data set received from the control system, controlling the wind turbine, by the monitoring system a reset value associated with Alarm ID 45 is missing somewhere between 10:40 and 10:50.

The method according to the present invention in a further embodiment provides for correcting the unreliable alarm value in respect of Alarm ID 45.

This is illustrated with reference to FIG. 2b.

FIG. 2b illustrates the same time span ranging from approximately 10:00 to approximately 12:10 as for the time range of FIG. 2a.

As we have learned above, a missing reset value is missing in respect of Alarm ID 45 at a point in time between 10:40 and 10:50, the next step will be to provide a corrected time stamp relating to the resetting of the Alarm ID 45.

This corrected time stamp is arrived at by determining the first point in time, subsequent to the time stamp representing the setting of the alarm ID 45 (approximately 10:17), at which the power production value (average power) shifts from indicating that no power is being produced to indicating that power is being produced (at 10:40), and then defining as the corrected reset time of the alarm, a moment in time following that first point in time. In the present example the power production value is power production averaged over time segments of a duration of 10 min. Therefore, in the present example, the corrected time stamp relating to the resetting of the Alarm ID 45 is selected as 10:40 plus half the time segment over which the power produced is being averaged (10 min/2). Thereby we arrive at a corrected time stamp relating to the resetting of the Alarm ID 45 of 10:45.

This is entered in the corrected data log CDL in the operative monitoring system as being a corrected time stamp of the resetting of the Alarm ID 45.

Thereby the corrected duration of the Alarm ID 45 will be approximately 10:17 to 10:45 as indicated by the solid bar in FIG. 2b.

It should be noted that in FIGS. 2a and 2b it is seen that the average power production reduces to zero in the period of time from 11:20 to 11:40. However, this may be due to the setting of another Alarm ID not being under consideration in this example.

### Example 2

This example illustrates another embodiment of the method of the present invention using the same wind turbine having the same components and set-up as the wind turbine of Example 1. Whereas Example 1 illustrated a situation in which a reset time stamp was missing, Example 2 illustrates a situation in which more set time stamps are missing.

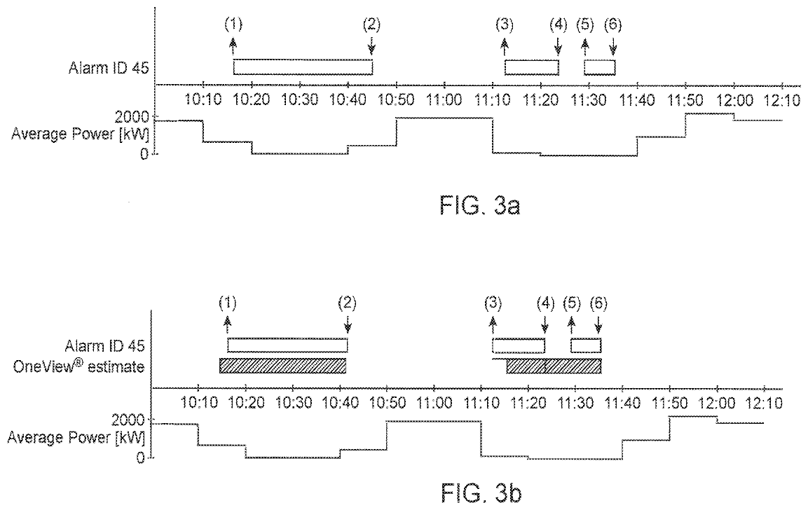

Referring to FIG. 3a, this figure illustrates a situation in which the Alarm ID 45 has been set and reset three times in the time span of approximately from 10:00 through 12:10. The Alarm ID is set first time at approximately 10:17 and then reset again at 10:45. These events are indicated by numerals (1) and (2), respectively. Subsequently, the Alarm ID 45 is set again at approximately 11:12 and reset again at approximately 11:23. These events are indicated by numerals (3) and (4), respectively. Finally, the Alarm ID 45 is set once again at approximately 11:29 and reset once again at approximately 11:36. These events are indicated by numerals (5) and (6), respectively.

In a case where, for some reason, the settings of the Alarm ID 45 (i.e. event (1), (3) and (5) in FIG. 3a) were not received by the monitoring system from the control system we would not know for which period of times the Alarm ID 45 was really causing a shut down of the wind turbine.

However, employing another aspect of the method of the present invention solves this problem.

This is illustrated in FIG. 3b.

In case only the reset events (2), (4) and (6) (and not the set events (1), (3) and (5)) in respect of Alarm ID 45 are received and no other set event of other alarm IDs are received we know that Alarm ID 45 must have been set at some point in time and hence that the wind turbine would have been shut down, as we register that the average power production reduces to zero between approximately 10:20 and 10:40 and then again between 11:20 and 11:40.

Accordingly, it can be concluded that the alarm value in respect of Alarm ID 45 (assuming that the time stamps of setting of alarm ID 45 at (1), (3) and (5) were not received) is unreliable in the time span ranging from approximately 10:00 to 12:10.

By using the method of the present invention, the missing or unreliable time stamps relating to the setting of Alarm ID 45 can be corrected.

This is done by utilizing information representing a power production value as a function of time, again represented by an average power production within time segments of 10 min. Looking at the average power production as a function of time in FIG. 3b it is seen that at 10:20 the power production reduces to zero, meaning that no power is being produced from this point in time.

As a corrected time stamp in respect of the setting (1) is defined the first point in time preceding the time stamp representing the resetting (at 10:40) of the alarm at which the power production value shifts from indicating that power is being produced to indicating that no power is being produced (at 10:20).

Again, in this example the power production value is power production averaged over time segments of a duration of 10 min. Therefore, in the present example, the corrected time stamp relating to the setting (1) of the Alarm ID 45 is selected as 10:20 minus haft the time segment over which the power produced is being averaged (10 min/2). Thereby we arrive at a corrected time stamp relating to the setting (1) of the Alarm ID 45 of 10:15.

This is entered in the data log in the monitoring system as being a corrected time stamp of the setting (1) of the Alarm ID 45.

Thereby the corrected time stamps associated with the setting (1) and the resetting (2) of the Alarm ID 45 will be 10:15 and approximately 10:42, respectively.

Moving on to the missing setting (3) of the Alarm ID 45 in FIG. 3b we employ the same method.

As a corrected time stamp of the missing set time (3) of the Alarm ID 45 we define a point in time following the first point in time preceding the time stamp representing the resetting (at event (4) at 11:23) of the alarm at which the power production value shifts from indicating that power is being produced to indicating that no power is being produced (at 11:20).

As the power production value in this example is power production averaged over time segments of a duration of 10 min., the corrected time stamp relating to the setting (3) of the Alarm ID 45 is selected as 11:20 minus half the time segment over which the power produced is being averaged (10 min/2). Thereby we arrive at a corrected time stamp relating to the setting of the Alarm ID 45 of 11:15.

This is entered in the data log in the monitoring system as being a corrected time stamp of the setting (3) of the Alarm ID 45.

In respect of the missing setting (5) of the Alarm ID 45 in FIG. 3b, we see that the first point in time preceding the time stamp representing the resetting (6) (at approximately 11:36) of the alarm at which the power production value shifts from indicating that power is being produced to indicating that no power is being produced (at 11:10), which corresponds to the setting (3) of the alarm ID 45.

For this reason the set value of the Alarm ID 45 continues from the time stamp associated with the setting (3) at 11:12 to the time stamp associated with the resetting (6) at 11:36. Thereby the time stamp (4) and (5) relating to resetting (4) and setting (5) of the Alarm ID 45 at times 11:30 and 11:23, respectively, will be very close or even coincide.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

WT Wind turbine
CS Control system
MS Monitoring system
DL Data log
CDL Corrected data log
OR Operational report originating from Data log
COR Corrected operational report originating from corrected data log
AI Alarm information
OI Operational information
S₁ Sensor No. 1 monitoring the operation of the wind turbine
S₂ Sensor No. 2 monitoring the operation of the wind turbine
S₃ Sensor No. 3 monitoring the operation of the wind turbine
S_{N} Sensor No. N monitoring the operation of the wind turbine
A_{ID 1} Information relating to alarms from Alarm ID 1
A_{ID 2} Information relating to alarms from Alarm ID 2
A_{ID 3} Information relating to alarms from Alarm ID 3
A_{ID M} Information relating to alarms from Alarm ID M
ST(1) Time stamp in respect of setting of alarm ID 1
ST(2) Time stamp in respect of setting of alarm ID 2
ST(3) Time stamp in respect of setting of alarm ID 3
ST(M) Time stamp in respect of setting of alarm ID M
RST(1) Time stamp in respect of resetting of alarm ID 1
RST(2) Time stamp in respect of resetting of alarm ID 2
RST(3) Time stamp in respect of resetting of alarm ID 3
RST(M) Time stamp in respect of resetting of alarm ID M

1-26. (canceled)

27. A computer-implemented method for monitoring alarm conditions of a wind turbine control system; said method comprising monitoring a monitoring system and a control system of a wind turbine during its operation;
wherein the monitoring system is connected to the control system;
wherein the control system produces operation information related to the operation of the wind turbine and alarm information related to events which could jeopardize the wind turbine or components thereof;
wherein the control system transmits the operation information and alarm information to the monitoring system;
wherein the monitoring system logs and stores the operational information and the alarm information in a original data log; and
wherein the monitoring comprises determining whether a discrepancy exists between the operational information and the alarm information in the first original data log, the determining comprising:
i) detecting one or more alarm values comprising one or more alarm IDs within the alarm information and, at the same time, registering one or more time stamps relating to a point in time corresponding to the one or more alarm IDs;
ii) detecting a power production value of said wind turbine within the operation information at the point in time corresponding to the one or more alarm IDs
iii) determining whether a discrepancy exists between the power production value and the one or more time stamps;
iv) annotating the one or more alarm values as being unreliable in case a discrepancy is determined.

28. The computer-implemented method according to claim 27, further comprising correcting said one or more alarm values, which in step iv) has been annotated as being unreliable.

29. The computer-implemented method according to claim 28, further comprising generating a corrected data log, which logs and stores corrected data, which represents original data which has been corrected.

30. The computer-implemented method according to claim 27, wherein the one or more alarm values is selected from the group consisting of one or more setting of an alarm having the one or more alarm ID and one or more resetting of and alarm having the one or more alarm ID.

31. The computer-implemented method according to claim 27, wherein the power production value is selected from the group comprising of information indicating that power is being produced by said wind turbine and information indicating that no power is being produced by said wind turbine.

32. The computer-implemented method according to claim 27, wherein the power production is selected from the group consisting of: power produced; torque exhibited by the rotor axle of the wind turbine (WT); angular velocity measured in respect of the rotor axle of the wind turbine (WT); current induced in the generator of the wind turbine (WT); voltage induced in the generator of the wind turbine (WT); and general information that the operational state of the wind turbine is being OK or not OK.

33. The computer-implemented method according to claim 27, further comprising step v) in case no discrepancy is determined in step iii); annotating said specific alarm value of said alarm ID as being reliable in said time span or in said portion thereof.

34. The computer-implemented method according to claim 27, where the alarm information related to events which could jeopardize the wind turbine or components thereof comprises: mechanical parameters; and/or grid parameters; and/or environmental parameters; and/or external command parameters; and/or normal operation parameters; and/or presence of condensate in the electrical system.

35. The computer-implemented method according to claim 34, wherein the mechanical parameters comprise undesirably low level of gear oil, undesirably high bearing temperature, stuck pitch actuator, and/or undesirably high yaw misalignment; the grid parameters comprise undesirably low grid frequency, undesirably high grid voltage, and/or phase asymmetry; the environment parameters comprise undesirably high wind speed, undesirably low ambient temperature, and/or undesirably low wind speed; the normal operation parameters comprise untwisting cables, performance of self-test, and/or state of heating component; and the external command parameters comprise remote stop instructions.

36. The computer-implemented method according to claim 27, wherein said method is being performed automatically.

37. The computer-implemented method according to claim 27, wherein said method is performed continuously or regularly during wind turbine operation.

38. The computer-implemented method according to claim 27, wherein said discrepancy is caused by lack of detection of a resetting of said alarm ID or is caused by lack of detection of a setting of said alarm ID.

39. The computer-implemented method according to claim 28, wherein said correction of said one or more alarm values comprises:
a) determine a first point in time, subsequent to the time stamp representing the setting of the alarm ID, at which the power production value shifts from indicating that no power is being produced to indicating that power is being produced; and
b) define as the corrected reset time of the alarm ID, a moment in time following said first point in time, as determined in step a).

40. The computer-implemented method according to claim 39, wherein the power production value is being provided as averaged values being averaged over a segment of time; and wherein step b) comprises:
define as the corrected reset time of the alarm ID, a moment in time falling in a time range having a starting point and an end point;
wherein said starting point of said time range being the first point in time, at which the power production value shifts from indicating that no power is being produced to indicating that power is being produced, as determined in step a); and
wherein said end point of said time range being a point in time falling subsequent to said starting point by a duration corresponding to duration of said time segment.

41. The computer-implemented method according to claim 28, wherein said discrepancy as determined in step iii) is caused by lack of detection of a setting of said one or more alarm IDs; wherein said correction of said one or more alarm values comprises:
a) determine a first point in time, preceding the one or more time stamps representing the resetting of the one or more alarm IDs, at which the power production value shifts from indicating that power is being produced to indicating that no power is being produced; and
b) define as a corrected set time of the one or more alarm IDs, a moment in time preceding said first point in time, as determined in step a).

42. The computer-implemented method according to claim 41, wherein the power production value is provided as averaged values being averaged over a segment of time; wherein step b) comprises:
define as a corrected set time of the one or more alarm IDs, a moment in time falling in a time range having a starting point and an end point;
wherein said end point of said time range being the first point in time, at which the power production value shifts from indicating that power is being produced to indicating that no power is being produced, as determined in step a);
wherein said starting point of said time range being a point in time falling prior to said end point by a duration corresponding to the duration of said time segment.

43. The computer-implemented method according to claim 27, wherein original data log comprises a data set relating to one or more of the group consisting of: the one or more alarm values being detected; information identifying the one or more alarm IDs in respect of which one or more alarm values are being detected; the time span in respect of which the one or more alarm values.

44. The computer-implemented method according to claim 29, wherein corrected data log comprises a data set relating to one or more of the group consisting of: the one or more alarm values being detected; information identifying the one or more alarm IDs in respect of which one or more alarm values are being detected; the time span in respect of which the one or more alarm values; the time span in respect of which the one or more alarm values are being annotated as being unreliable, any corrected alarm values as determined by said method, and optionally also the corresponding corrected time stamps relating to settings and/or resettings of an alarm ID.

45. The computer-implemented method according to claim 29, wherein said original data and said corrected data independently is selected from the group comprising: alarm ID, original time stamps relating to setting times and/or resetting times of a specific alarm ID, corrected time stamps relating to setting times and/or resetting times of a specific alarm ID; information relating to the power production value as a function of time.

46. The computer-implemented method according to claim 31, wherein said power production value of said wind turbine further and/or alternatively comprises: information indicating that power potentially could be produced by said wind turbine in its current state, and information indicating that no power potentially could be produced by said wind turbine in its current state.

47. A non-transitory computer-readable medium for monitoring system and a control system of a wind turbine during its operation; comprising instructions stored thereon, that when executed on a processor, performs the steps of:
determining whether a discrepancy exists between operational information and alarm information produced by a wind turbine control system and transmitted to a wind turbine monitoring system, wherein the monitoring system logs and stores the operational information and the alarm information in a first original data log, the determining comprising:
i) detecting one or more alarm values comprising one or more alarm IDs within the alarm information and, at the same time, registering one or more time stamps relating to a point in time corresponding to the one or more alarm IDs;
ii) detecting a power production value of said wind turbine within the operation information at the point in time corresponding to the one or more alarm IDs;
iii) determining whether a discrepancy exists between the power production value and the one or more time stamps;
iv) annotating the one or more alarm values as being unreliable in case a discrepancy is determined.

48. The non-transitory computer-readable medium according to claim 47, further comprising instructions stored thereon for performing the step of correcting said one or more alarm values, which in step iv) has been annotated as being unreliable.

49. The non-transitory computer-readable medium according to claim 48, further comprising instructions stored thereon for performing the step of generating a second corrected data log, which logs and stores corrected data, which represents original data which has been corrected.
